(19) United States
(12) Patent Application Publication
(10) Pub. No.: US 2026/0254884 A1
(43) Pub. Date: Aug. 27, 2026

(54) SYSTEMS AND METHODS FOR FLEXIBLE INTEGRATION OF SERVICES INTO EXISTING FLOWS

(71) Applicant: JPMORGAN CHASE BANK, N.A., New York, NY (US)

(72) Inventors: Kumar Rao KRISHNAGI, Powell, OH (US); Suresh MADHAVAN, Edison, NJ (US); Jai CHAWLA, Livingston, NJ (US); Kalpana JAYARAMAN, Newark, NJ (US); Ganesan JAYARAMAN, Delaware, OH (US)

(21) Appl. No.: 19/060,312

(22) Filed: Feb. 21, 2025

(51) Int. Cl. H04L 67/63; G06Q 10/0635; H04L 9/40

(52) U.S. Cl. CPC H04L 67/63; G06Q 10/0635; H04L 63/0861

(57) ABSTRACT

Systems and methods for flexible integration of services into existing flows are disclosed. A method may include: (1) receiving, by an interceptor computer program, a request for a service from a user electronic device, wherein the service is one of a plurality of services available to the user electronic device; (2) determining, by the interceptor computer program, that the service requires a risk assessment; (3) routing, by the interceptor computer program, the request to a service orchestrator, wherein the service orchestrator routes the request to a risk assessment orchestrator; (4) receiving, by the interceptor computer program and from the service orchestrator, a risk assessment from the risk assessment orchestrator and a token generated by the service orchestrator; and (5) routing, by the interceptor computer program, the request to a system associated with the service in response to the risk assessment being below a threshold.

### BACKGROUND OF THE INVENTION

### 1. Field of the Invention

Embodiments are generally directed to systems and methods for flexible integration of services into existing flows.

### 2. Description of the Related Art

Integrating a new service into existing applications is a time-consuming process that requires significant re-engineering efforts. For example, the integration between products and risk ecosystems is a bespoke process that requires specific development efforts from each team. This often leads to delays, significantly pushing back the required integration timeline. Delays will eventually increase the development costs, necessitating comprehensive testing across all remaining systems.

### SUMMARY OF THE INVENTION

Systems and methods for flexible integration of services into existing flows are disclosed. In one embodiment, a method may include: (1) receiving, by an interceptor computer program, a request for a service from a user electronic device, wherein the service is one of a plurality of services available to the user electronic device; (2) determining, by the interceptor computer program, that the service requires a risk assessment; (3) routing, by the interceptor computer program, the request to a service orchestrator, wherein the service orchestrator routes the request to a risk assessment orchestrator; (4) receiving, by the interceptor computer program and from the service orchestrator, a risk assessment from the risk assessment orchestrator and a token generated by the service orchestrator; and (5) routing, by the interceptor computer program, the request to a system associated with the service in response to the risk assessment being below a threshold.

In one embodiment, the interceptor computer program determines that the service requires the risk assessment based on an endpoint URL for the service.

In one embodiment, the interceptor computer program determines that the service requires the risk assessment based on a presence or an absence of the service on a list of services.

In one embodiment, the risk assessment is returned in a red-amber-green format or as a numeric risk score.

In one embodiment, the token comprises an identification of the risk assessment orchestrator and the risk assessment.

In one embodiment, the method may also include: determining, by the interceptor computer program, that additional authentication is needed based on the risk assessment; and routing, by the interceptor computer program, the request and the risk assessment to a challenge as a service module, wherein the challenge as a service module performs step-up authentication.

In one embodiment, the step-up authentication comprises out of band authentication and/or biometric authentication.

In one embodiment, the risk assessment orchestrator assesses risk for more than one of the plurality of services.

According to one embodiment, a system may include: a user electronic device executing a user computer program; and a backend electronic device executing an interceptor computer program, a service orchestrator computer program, a risk assessment orchestrator computer program, and a plurality of services. The interceptor computer program receives a request for a service from the user computer program executed by the user electronic device, wherein the service is one of the plurality of services available to the user electronic device; the interceptor computer program determines that the service requires a risk assessment; the interceptor computer program routes the request to the service orchestrator computer program; the service orchestrator computer program routes the request to the risk assessment orchestrator computer program; the risk assessment orchestrator computer program performs a risk assessment on the request; the service orchestrator computer program receives the risk assessment; the service orchestrator computer program generates a token for the risk assessment, wherein the token indicates a success of the risk assessment; the interceptor computer program receives the risk assessment and the token; and the interceptor computer program routes the request to a system associated with the service in response to the risk assessment being below a threshold.

In one embodiment, the interceptor computer program determines that the service requires the risk assessment based on an endpoint URL for the service.

In one embodiment, the interceptor computer program determines that the service requires the risk assessment based on a presence or an absence of the service on a list of services.

In one embodiment, the risk assessment is returned in a red-amber-green format or as a numeric risk score.

In one embodiment, the token further comprises an identification of the risk assessment orchestrator computer program.

In one embodiment, the backend electronic device further comprises a challenge as a service module; and the interceptor computer program determines that additional authentication is needed based on the risk assessment; and the interceptor computer program routes the request and the risk assessment to a challenge as a service module, wherein the challenge as a service module performs step-up authentication.

In one embodiment, the step-up authentication comprises out of band authentication and/or biometric authentication.

In one embodiment, the risk assessment orchestrator computer program assesses risk for more than one of the plurality of services.

According to another embodiment, a non-transitory computer readable storage medium may include instructions stored thereon, which when read and executed by one or more computer processors, cause the one or more computer processors to perform steps comprising: receiving a request for a service from a user electronic device, wherein the service is one of a plurality of services available to the user electronic device; determining that the service requires a risk assessment based on an endpoint URL for the service or based on a presence or an absence of the service on a list of services; performing a risk assessment on the request; and generating a token based on the risk assessment; routing the request to a system associated with the service in response to the risk assessment being below a threshold.

In one embodiment, the token comprises an identification of a risk assessment orchestrator and the risk assessment.

In one embodiment, the non-transitory computer readable storage medium may also include instructions stored thereon, which when read and executed by the one or more computer processors, cause the one or more computer processors to perform steps comprising: determining that additional authentication is needed based on the risk assessment; and routing the request and the risk assessment to a challenge as a service module, wherein the challenge as a service module performs step-up authentication.

In one embodiment, the step-up authentication comprises out of band authentication and/or biometric authentication.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for flexible integration of services into existing flows according to an embodiment;

FIG. 2 illustrates a method for flexible integration of services into existing flows according to an embodiment; and

FIG. 3 depicts an exemplary computing system for implementing aspects of the present disclosure.

### DETAILED DESCRIPTION OF PREFERRED EMBODIMENTS

Systems and methods for flexible integration of services into existing flows are disclosed.

Embodiments may use an interceptor that may receive a request from a customer electronic device for a service and may route the request to a risk assessment module for a risk assessment. The risk assessment module may call an artificial intelligence/machine learning model to assess risk by calling any required systems. This eliminates the on-boarding and re-engineering work.

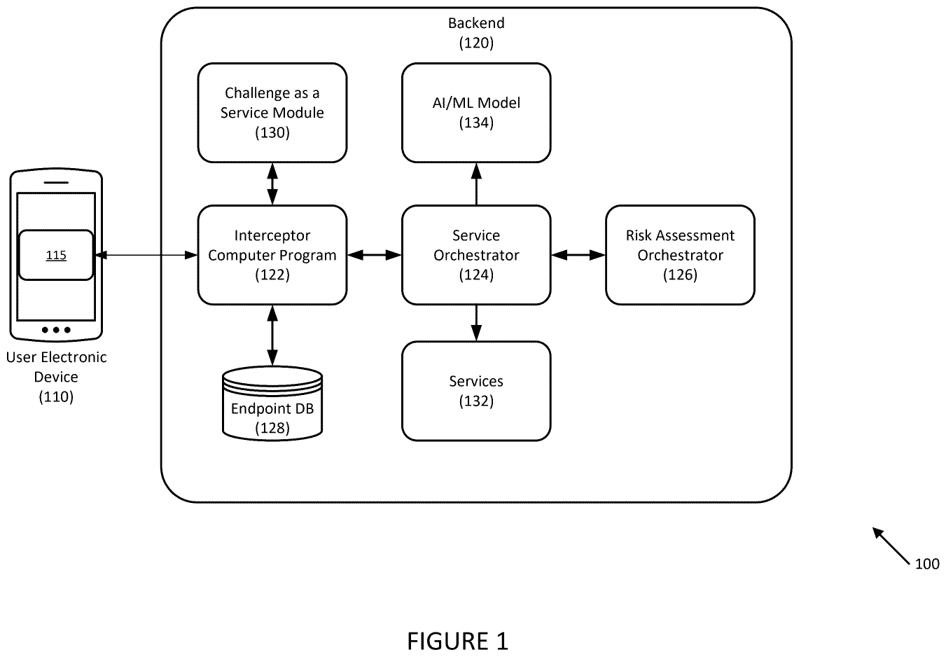

Referring to FIG. 1, a system for flexible integration of services into existing flows is disclosed according to an embodiment. System 100 may include user electronic device 110, which may be a computer (e.g., workstation, desktop, laptop, notebook, tablet, etc.), smart device (e.g., smart phone, smart watch, etc.), an Internet of Things (IoT) appliance, etc. User electronic device 110 may execute user computer program 115, which may be an application, a program, a browser, etc. that may interface with backend 120.

Backend 120 may be an electronic device, such as a server (e.g., physical and/or cloud-based) that may execute modules (e.g., computer programs or applications), such as interceptor computer program 122, service orchestrator 124, and risk assessment orchestrator 126. Interceptor computer program 122 may receive a request from user computer program 115 for one or more service 132 and may identify the URL endpoint for the service. Using a mapping in endpoint database 128, interceptor computer program 122 computer program, may determine if the service is calling a URL endpoint that is to be routed to a service, such as risk assessment orchestrator 126.

Service orchestrator 124 may gather data from all API calls at the conclusion of the transaction, reformat the data, and generate a payload that meets the requirements of the target system's API.

Risk assessment orchestrator 126 may receive the request from interceptor computer program 122 and may assess a risk using AI/ML model 134. AI/ML model 134 may be trained on all user transactions and may leverage this data to detect fraudulent activities. AI/ML model 134 may also assess factors such as the user's location, transaction type, whether the user is connected to a public Wi-Fi or in a shared location, etc. If any of these conditions are identified, additional verification steps may be implemented.

In one embodiment, every request from user electronic device 110 may flow through AI/ML model 134, and AI/ML model 134 may first determine whether a risk assessment is needed. If a risk assessment it is deemed necessary, a subsequent request will trigger the risk verification process.

Interceptor computer program 122 may use the risk assessment from risk assessment orchestrator to determine whether to call challenge as a service module 130, which may provide step-up authentication services (e.g., out-of-band authentication, biometric authentication, etc.).

Interceptor computer program 122 may further route the request to one or more services 132 for processing. Service(s) 132 may execute the request.

Services 132 may be any service that may require authorization before executing a request. For example, in the financial industry, examples of services 132 may include card replacement, transaction execution, money transfers, bill payments etc. Examples in other industries may include password changes, access requests, delegation requests, account locking and unlocking, access revocation, etc.

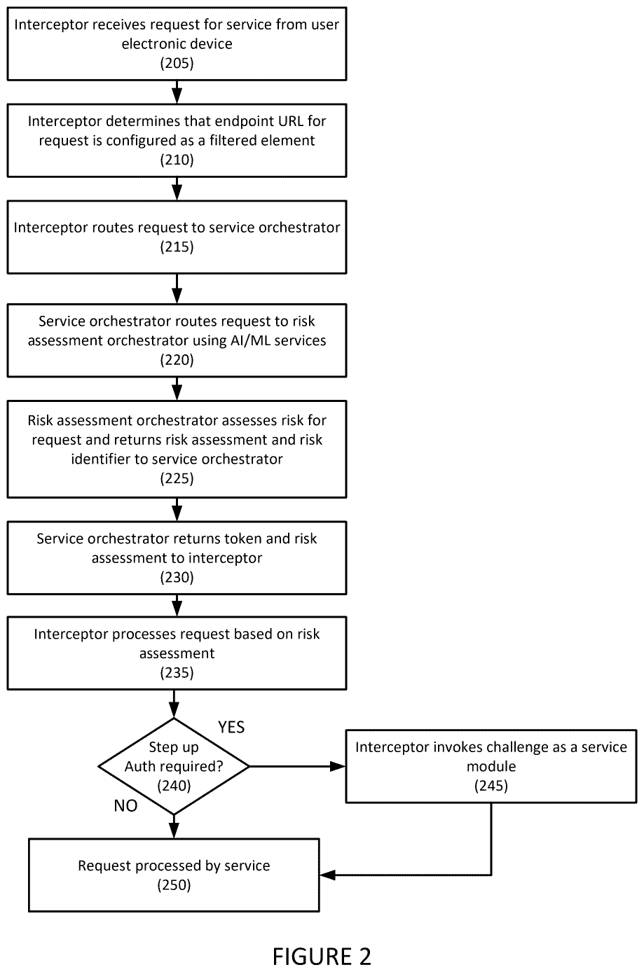

Referring to FIG. 2, a method for flexible integration of services into existing flows is disclosed according to an embodiment.

In step 205, an interceptor computer program executed by a backend may receive a request for a service from a user electronic device.

In step 210, the interceptor computer program may determine that the endpoint URL for the requested service is configured as a filtered element. For example, the particular request may be associated with a service that is to be assessed for risk.

In one embodiment, the interceptor computer program may determine whether the requested service is present or absent on a list of services. For example, the requested service may be present on a list of service that require risk assessment, or may not be on a list of services that do not need risk assessment.

In step 215, the interceptor computer program may route the request to a service orchestrator, which, in step 220, may route the request to a risk assessment orchestrator.

In step 225, the risk assessment orchestrator may assess the risk for the request and may return the risk assessment and a risk identifier to the service orchestrator. In one embodiment, the risk assessment orchestrator may be modified and or/updated as is necessary without requiring significant programming.

In addition, more than one service may use the same risk assessment orchestrator.

In step 230, the service orchestrator may generate and return a token and a risk assessment to the interceptor computer program. The token indicates the success of the risk assessment. The token may include any information as is necessary and/or desired, such as the result of the risk assessment and an identification of the service orchestrator.

The interceptor computer program may then forward the token to the challenge as a service module, which validates the token to confirm that the risk assessment was initiated by the service orchestrator, thereby ensuring the authenticity of the service orchestrator.

The risk assessment may be provided in any desired format, such as red-amber-green, a numeric risk score, a letter risk score, etc.

In step 235, the interceptor computer program may process the request based on the risk assessment. Different risk assessments may require different actions. For example, in step 240, if the risk assessment is above a certain level, in step 245, interceptor computer program may invoke a challenge as a service module, which may perform step-up authentication for the user (e.g., out of band authentication, biometric authentication, etc.).

If, in step 240, step up authentication is not required, in step 250, the interceptor computer program may route the request to systems for the service for processing.

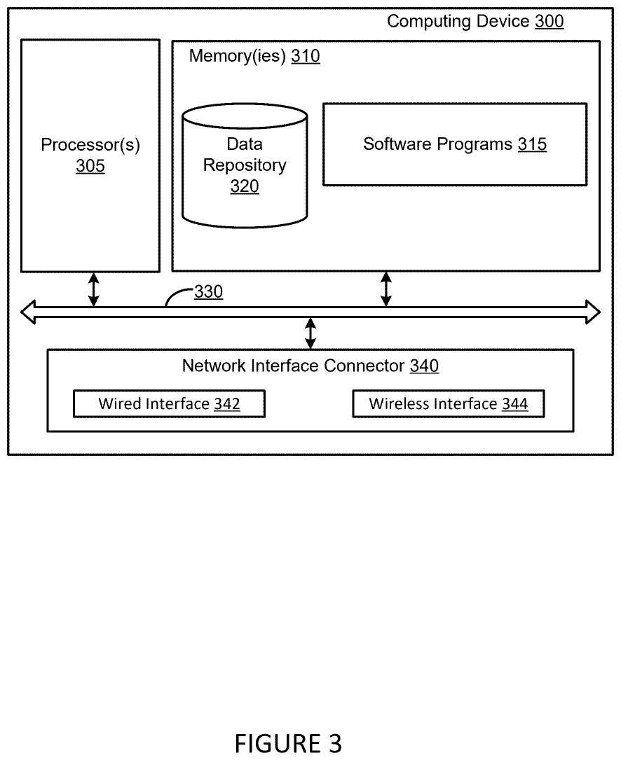

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity, i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by an interceptor computer program, a request for a service from a user electronic device, wherein the service is one of a plurality of services available to the user electronic device;
determining, by the interceptor computer program, that the service requires a risk assessment;
routing, by the interceptor computer program, the request to a service orchestrator, wherein the service orchestrator routes the request to a risk assessment orchestrator;
receiving, by the interceptor computer program and from the service orchestrator, a risk assessment from the risk assessment orchestrator and a token generated by the service orchestrator; and
routing, by the interceptor computer program, the request to a system associated with the service in response to the risk assessment being below a threshold.

2. The method of claim 1, wherein the interceptor computer program determines that the service requires the risk assessment based on an endpoint URL for the service.

3. The method of claim 1, wherein the interceptor computer program determines that the service requires the risk assessment based on a presence or an absence of the service on a list of services.

4. The method of claim 1, wherein the risk assessment is returned in a red-amber-green format or as a numeric risk score.

5. The method of claim 1, wherein the token comprises an identification of the risk assessment orchestrator and the risk assessment.

6. The method of claim 1, further comprising:
determining, by the interceptor computer program, that additional authentication is needed based on the risk assessment; and
routing, by the interceptor computer program, the request, the token, and the risk assessment to a challenge as a service module, wherein the challenge as a service module performs step-up authentication.

7. The method of claim 6, wherein the step-up authentication comprises out of band authentication and/or biometric authentication.

8. The method of claim 1, wherein the risk assessment orchestrator assesses risk for more than one of the plurality of services.

9. A system, comprising:
a user electronic device executing a user computer program; and
a backend electronic device executing an interceptor computer program, a service orchestrator computer program, a risk assessment orchestrator computer program, and a plurality of services;
wherein:
the interceptor computer program receives a request for a service from the user computer program executed by the user electronic device, wherein the service is one of the plurality of services available to the user electronic device;
the interceptor computer program determines that the service requires a risk assessment;
the interceptor computer program routes the request to the service orchestrator computer program;
the service orchestrator computer program routes the request to the risk assessment orchestrator computer program;
the risk assessment orchestrator computer program performs a risk assessment on the request;
the service orchestrator computer program receives the risk assessment;
the service orchestrator computer program generates a token for the risk assessment, wherein the token indicates a success of the risk assessment;
the interceptor computer program receives the risk assessment and the token; and
the interceptor computer program routes the request to a system associated with the service in response to the risk assessment being below a threshold.

10. The system of claim 9, wherein the interceptor computer program determines that the service requires the risk assessment based on an endpoint URL for the service.

11. The system of claim 9, wherein the interceptor computer program determines that the service requires the risk assessment based on a presence or an absence of the service on a list of services.

12. The system of claim 9, wherein the risk assessment is returned in a red-amber-green format or as a numeric risk score.

13. The system of claim 9, wherein the token further comprises an identification of the risk assessment orchestrator computer program.

14. The system of claim 9, wherein the backend electronic device further comprises a challenge as a service module; and
the interceptor computer program determines that additional authentication is needed based on the risk assessment; and
the interceptor computer program routes the request, the token, and the risk assessment to a challenge as a service module, wherein the challenge as a service module performs step-up authentication.

15. The system of claim 14, wherein the step-up authentication comprises out of band authentication and/or biometric authentication.

16. The system of claim 9, wherein the risk assessment orchestrator computer program assesses risk for more than one of the plurality of services.

17. A non-transitory computer readable storage medium, including instructions stored thereon, which when read and executed by one or more computer processors, cause the one or more computer processors to perform steps comprising:
receiving a request for a service from a user electronic device, wherein the service is one of a plurality of services available to the user electronic device;
determining that the service requires a risk assessment based on an endpoint URL for the service or based on a presence or an absence of the service on a list of services;
performing a risk assessment on the request;
generating a token based on the risk assessment; and
routing the request to a system associated with the service in response to the risk assessment being below a threshold.

18. The non-transitory computer readable storage medium of claim 17, wherein the token comprises an identification of a risk assessment orchestrator and the risk assessment.

19. The non-transitory computer readable storage medium of claim 17, further including instructions stored thereon, which when read and executed by the one or more computer processors, cause the one or more computer processors to perform steps comprising:
determining that additional authentication is needed based on the risk assessment; and
routing the request and the risk assessment to a challenge as a service module, wherein the challenge as a service module performs step-up authentication.

20. The non-transitory computer readable storage medium of claim 19, wherein the step-up authentication comprises out of band authentication and/or biometric authentication.
